(19) United States
(12) Patent Application Publication
(10) Pub. No.: US 2004/0252894 A1
(43) Pub. Date: Dec. 16, 2004

(54) Image compression apparatus and image processing system

(75) Inventor: Makoto Miyanohara, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 10/859,196

(22) Filed: Jun. 3, 2004

(30) Foreign Application Priority Data
Jun. 11, 2003 (JP) 2003-165887

(51) Int. Cl. G06K 9/36

(52) U.S. Cl. 382/232

(57) ABSTRACT

Disclosed herein is an image compression apparatus for compressing color imaging signals outputted from a solid-state imaging device having a color filter arranged in a Bayer array stuck on a light receiving surface thereof, including: a pre-processing section for fetching signals from the color imaging signals outputted from the solid-state imaging device with treating the signals of 2×2 pixels corresponding to the Bayer array containing at least each color component signal as a unit, the pre-processing section for, with respect to each unit, generating a luminance signal and one chrominance signal from R signal, one G signal and B signal and generating the luminance signal and the other chrominance signal from the R signal, the other G signal and the B signal of one unit; and a compression section having a frequency conversion section for computing spatial frequency components block by block of each signal component with respect to the luminance signals and two types of chrominance signals outputted from the pre-processing section, a quantization section for quantizing the spatial frequency components, and an encoding section for encoding the quantized spatial frequency components.

This application claims benefit of Japanese Patent Application No.2003-165887 filed in Japan on Jun. 11, 2003, the contents of which are incorporated by this reference.

### BACKGROUND OF THE INVENTION

The present invention relates to image compression apparatus for compressing color imaging signals and image processing system for effecting compression, expansion and reproduction of color imaging signals, and more particularly relates to image compression apparatus and image processing system suitably used in those products such as a capsular endoscope or mobile phone in which power saving and size reduction are demanded more than image quality.

FIG. 1 is a block diagram showing an example of general image processing system. In FIG. 1, numeral 101 denotes an imaging apparatus. The imaging apparatus 101 has a solid-state imaging device for receiving light from an object to output color imaging signals corresponding to the received light amount. The color imaging signals from the solid-state imaging device are transmitted as image data. To achieve an efficient transmission of image data, the image data are usually transmitted by way of processing at an image data compression apparatus 102. The image data compression apparatus 102 effects a compression processing based on the standard for example of JPEG (Joint Photographic Expert Group) or MPEG (Moving Picture Expert Group) for the inputted image data and subsequently transmits the compressed image data.

Supposing a single-chip sensor, solid-state imaging device, in order to reduce degradation of image data due to the compression processing at the image data compression apparatus 102, the prior-art imaging apparatus 101 first effects a matrix operation to convert color imaging signals obtained by image taking into R (red), G (green), B (blue) signals, i.e., a total number of signals three times the total number of the color imaging signals (color-interpolating). Subsequently, these color signals are subjected to a separate matrix operation to generate luminance signal Y and chrominance signals U, V which are the signals to be inputted into the image data compression apparatus 102.

An image data expansion apparatus 103 having received the transmitted, compressed image data then effects an expansion processing based on the standard. At an image reproduction apparatus 104, then, Y, U, V signals obtained by the expansion processing are converted into R, G, B signals by means of an inverse operation of the matrix operation to display them as an image.

A more detailed explanation will be given below by way of FIG. 2 with the image processing system as described above which includes: the imaging apparatus 101; image data compression apparatus 102 for compressing image data outputted from the imaging apparatus 101; image data expansion apparatus 103 for expanding the compressed image data outputted from the image data compression apparatus 102; and image reproduction apparatus 104.

As shown in FIG. 2, a front-end section 201 includes a color filter 201-1, solid-state imaging device 201-2, simultaneous section 201-3, and luminance/chrominance signal conversion section 201-4. The color filter 201-1 is formed by the color filter elements of R, G, B that are arranged in a Bayer method for example as shown in FIG. 4A to be described later. The color filter 201-1 is then stuck onto a front side of the solid-state imaging device 201-2 so that light from an object enters the solid-state imaging device 201-2 through the color filter 201-1.

The solid-state imaging device 201-2 is for receiving the light from the object through the color filter 201-1 to output color imaging signals corresponding to the received light amount and is provided with a plurality of light receiving elements corresponding to each color filter element of the color filter 201-1. The output from the solid-state imaging device 201-2 is inputted into the simultaneous section 201-3 as color imaging signals. The simultaneous section 201-3 is a circuit for generating R, G, B signals based on the color imaging signals outputted from the solid-state imaging device 201-2 (color-interpolating), and the generated R, G, B signals are inputted into the luminance/chrominance signal conversion section 201-4. The luminance/chrominance signal conversion section 201-4 is for generating Y, U, V based on the R, G, B signals outputted from the simultaneous section 201-3.

These Y, U, V signals generated at the front-end section 201 are to be inputted as image data into an image compression section 202. As shown in FIG. 2, the image compression section 202 includes a frequency conversion section 202-1, quantizing section 202-2, and encoding section 202-3. The frequency conversion section 202-1 is for computing spatial frequency components for Y, U, V signals within each predetermined block. In a standard of JPEG, for example, one block is constituted by eight signals horizontally and eight signals vertically, i.e., 8×8 signals for each block of Y, U, V, and these 8×8 signals are subjected to DCT (discrete cosine transformation), a type of orthogonal transformation, to be converted into spatial frequency components (DCT coefficient).

The spatial frequency components are inputted into the quantizing section 202-2. The quantizing section 202-2 is for effecting quantization of the spatial frequency components outputted from the frequency conversion section 202-1. The quantized spatial frequency components outputted from the quantizing section 202-2 are inputted into the encoding section 202-3. The encoding section 202-3 is for forming code data for the quantized spatial frequency components outputted from the quantizing section 202-2. In a standard of JPEG, for example, after a zigzag scanning, Huffman coding and run length coding are effected on the quantized spatial frequency components outputted from the quantizing section 202-2.

The code data are inputted into an expansion section 203. As shown in FIG. 2, the expansion section 203 includes a decoding section 203-1, inverse quantizing section 203-2, and inverse frequency conversion section 203-3. The expansion section 203 is for effecting an expansion processing corresponding to the compression effected at the image compression section 202 and outputs Y, U, V signals. In a standard of JPEG, for example, a run-length decoding, Huffman decoding, inverse quantization, and inverse DCT are effected.

The Y, U, V signals outputted from the expansion section 203 are inputted into a back-end section 204. As shown in FIG. 2, the back-end section 204 includes a color signal converting section 204-1. The color signal converting section 204-1 is for generating R, G, B signals based on the Y, U, V signals outputted from the expansion section 203.

### SUMMARY OF THE INVENTION

It is an object of the present invention to provide an image compression apparatus and image processing system in which the process from an imaging of object through the compression of image data obtained by the imaging is effected with saving power based on a reduction of data to be processed so that power saving and a reduction in size can be achieved up to the means for compressing color imaging signals obtained from a solid-state imaging device.

In a first aspect of the invention, there is provided an image compression apparatus for compressing color imaging signals outputted from a solid-state imaging device having a color filter arranged in a Bayer array stuck on a light receiving surface thereof, including: a pre-processing section for fetching signals from the color imaging signals outputted from the solid-state imaging device with treating the signals of 2×2 pixels corresponding to the Bayer array containing at least each color component signal as a unit, the pre-processing section for, with respect to each unit, generating a luminance signal and one chrominance signal from R signal, one G signal and B signal and generating the luminance signal and the other chrominance signal from the R signal, the other G signal and the B signal of one unit; and a compression section having a frequency conversion section for computing spatial frequency components block by block of each signal component with respect to the luminance signals and two types of chrominance signals outputted from the pre-processing section, a quantization section for quantizing the spatial frequency components, and an encoding section for encoding the quantized spatial frequency components.

In a second aspect of the invention, there is provided an image processing system including:

an image compression apparatus having: a pre-processing section for fetching signals from color imaging signals outputted from a solid-state imaging device having a color filter arranged in a Bayer array stuck on a light receiving surface thereof with treating the signals of 2×2 pixels corresponding to the Bayer array containing at least each color component signal as a unit, the pre-processing section for, with respect to each unit, generating a luminance signal and one chrominance signal from R signal, one G signal and B signal and generating the luminance signal and the other chrominance signal from the R signal, the other G signal and the B signal of one unit; and a compression section having a frequency conversion section for computing spatial frequency components block by block of each signal component with respect to the luminance signals and two types of chrominance signals outputted from the pre-processing section, a quantization section for quantizing the spatial frequency components, and an encoding section for encoding the quantized spatial frequency components;

an expansion section having a decoding section for decoding spatial frequency components from the encoded data outputted from the image compression apparatus, an inverse quantization section for effecting an inverse quantization of the decoded spatial frequency components, and an inverse frequency conversion section for computing luminance signals and two types of chrominance signals block by block of each signal component based on the inverse-quantized spatial frequency components; and

a back-end section for generating image signals from the luminance signals and two types of chrominance signals outputted from the expanding section.

In a third aspect of the invention, the back-end section in the image processing system according to the second aspect is a format conversion section for generating image signals in an outputting format required by an external equipment from the luminance signals and two types of chrominance signals outputted from the expansion section.

In a fourth aspect of the invention, the format conversion section in the image processing system according to the third aspect includes: an inverse luminance/chrominance signal conversion section for generating color signals from the luminance signals and two types of chrominance signals outputted from the expansion section; and an image signal generation section for color-interpolating the color signals generated from the inverse luminance/chrominance signal conversion section.

In a fifth aspect of the invention, the format conversion section in the image processing system according to the third aspect includes: an image signal generation section for color-interpolating the luminance signals and two types of chrominance signals outputted from the expansion section; and an inverse luminance/chrominance signal conversion section for generating color signals from the color-interpolated luminance signal and two types of chrominance signals.

### BRIEF DESCRIPTION OF THE DRAWINGS

FIG. 1 is a block diagram schematically showing a general image processing system.

FIG. 2 is a block diagram showing an example of construction of conventional image processing system.

FIG. 3 is a block diagram showing an embodiment of the image processing apparatus according to the invention.

FIGS. 4A and 4B each are a top view showing an example of construction of color filter to be used in the solid-state imaging device of the front-end section of the embodiment shown in FIG. 3.

FIGS. 5A, 5B and 5C show luminance signals Y, and two types of chrominance signals U, V generated at the pre-processing section of the front-end section shown in FIG. 3.

FIG. 6 shows a pixel array of solid-state imaging device corresponding to the case where a Bayer-arrayed primary-color filter is used as the color filter.

FIG. 7 shows a unit array of 2×2 pixels extracted from the pixel array shown in FIG. 6.

FIG. 8 shows a pixel array of solid-state imaging device corresponding to the case where a complementary-color filter is used as the color filter.

FIGS. 9A, 9B and 9C show the manner of effecting color-interpolating for the color signals in Bayer array obtained at the inverse luminance/chrominance signal conversion section of the back-end section.

FIG. 10 is a block diagram showing a modification of the back-end section.

FIG. 11 shows the manner of effecting color-interpolating for the luminance signals and two types of chrominance signals obtained from the expansion section at the image signal generation section in the modification of the back-end section shown in FIG. 10.

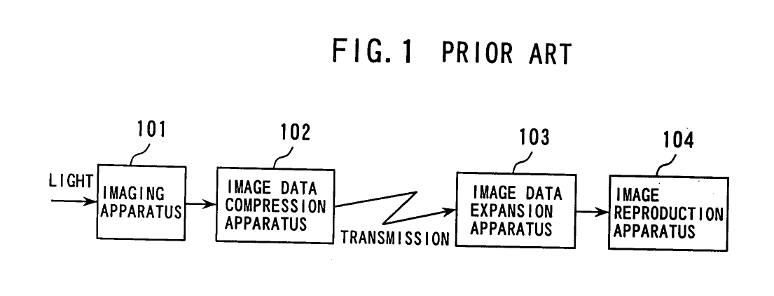

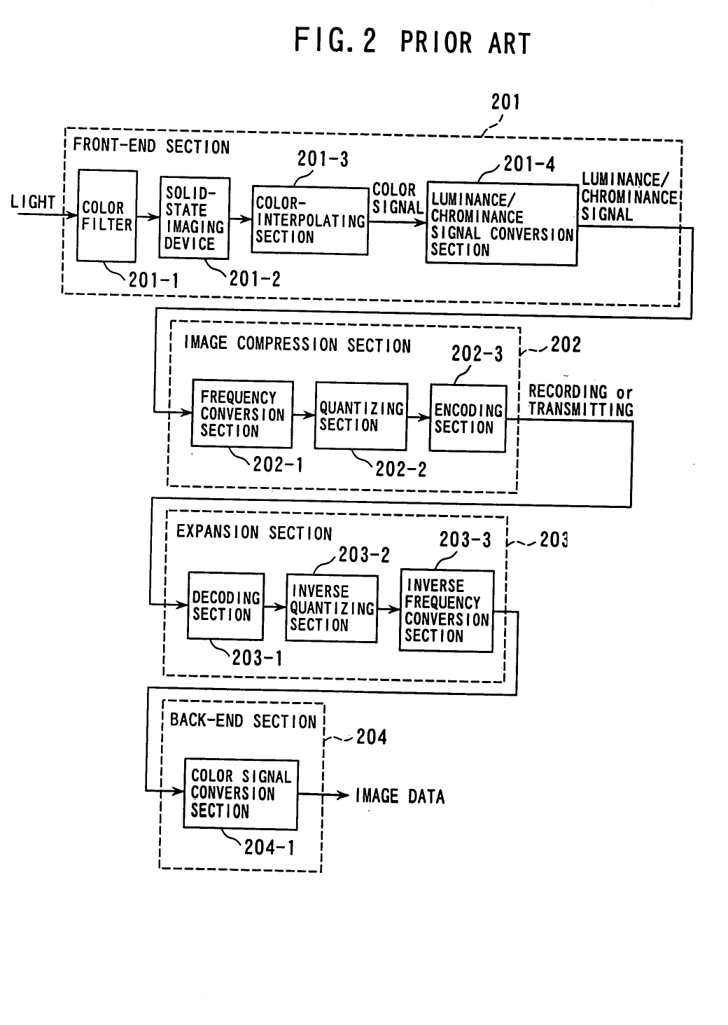

### DESCRIPTION OF THE PREFERRED EMBODIMENTS

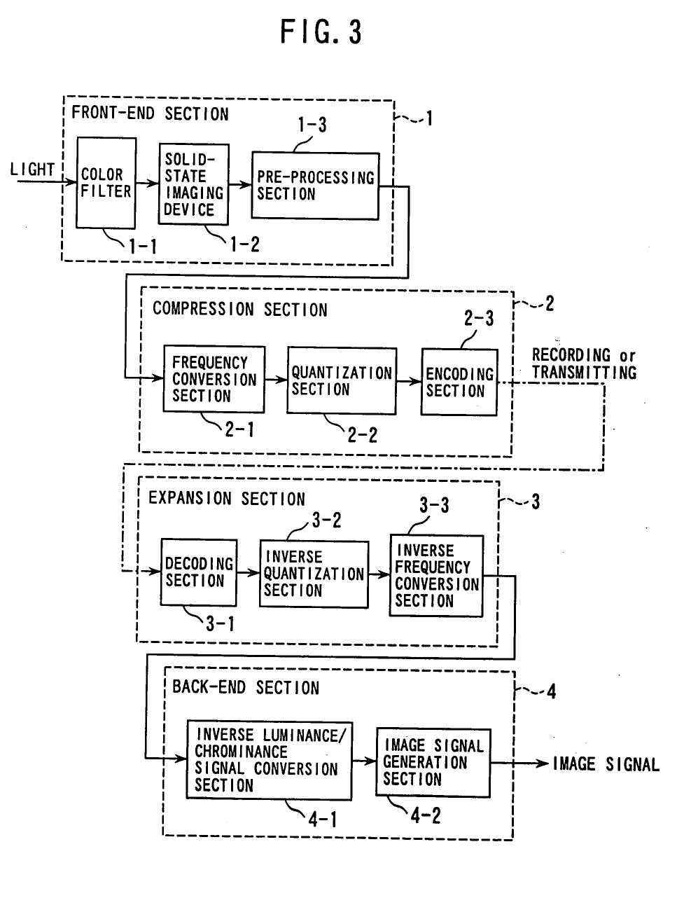

Some embodiments of the present invention will now be described. FIG. 3 is a block diagram schematically showing the construction of an image processing system according to an embodiment of the present invention. The image processing system includes: a front-end section 1 containing a color filter 1-1, a single-chip sensor solid-state imaging device 1-2 having the color filter disposed on a light receiving surface thereof, and a pre-processing section 1-3; an image compression section 2 containing a frequency conversion section 2-1, quantizing section 2-2 and encoding section 2-3; an expansion section 3 containing a decoding section 3-1, inverse quantizing section 3-2, and inverse frequency conversion section 3-3; and a back-end section 4 containing an inverse luminance/chrominance signal conversion section 4-1 and image signal generation section 4-2.

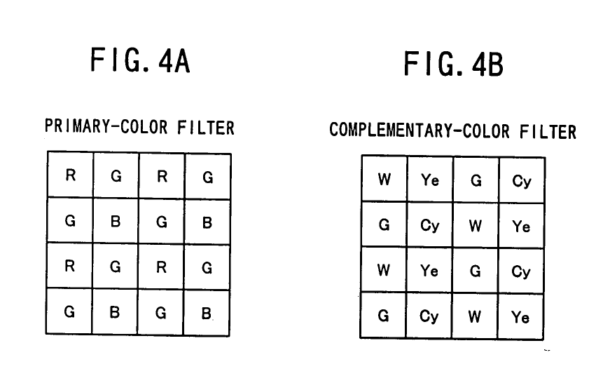

The front-end section 1 is for receiving light from an object to generate luminance signals Y and chrominance signals U, V in a predetermined format and as previously described includes the color filter 1-1, solid-state imaging device 1-2, and pre-processing section 1-3. A primary-color filter having color filter elements of R (red), G (green), B (blue) arranged in a Bayer array for example as shown in FIG. 4A is used as the color filter 1-1. The color filter 1-1 is disposed on the front face of the solid-state imaging device 1-2 so that the light from the object enters the solid state imaging device 1-2 through the color filter 1-1. It should be noted that a complementary-color filter as shown in FIG. 4B may also be used as the color filter 1-1.

The solid-state imaging device 1-2 is for receiving the light from the object through the color filter 1-1 to output color imaging signals in accordance with the received light amount and has a plurality of light receiving pixels corresponding to the color filter 1-1.

The pre-processing section 1-3 is for generating the luminance signals Y and chrominance signals U, V in a predetermined format from all color imaging signals that are outputted from the solid-state imaging device 1-2 in accordance with the disposition of each color filter element of the color filter 1-1. The method of generating the predetermined-format luminance signal Y and chrominance signals U, V will be described later in detail. The predetermined-format luminance signal Y and chrominance signals U, V generated as the above are inputted into the compression section 2.

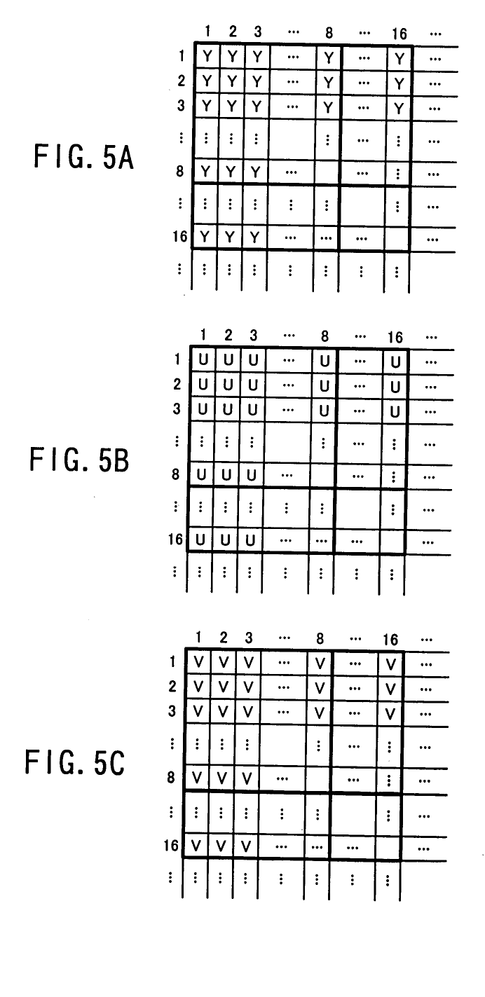

The processing operation at the compression section 2 and expansion section 3 will be described in the following. A description will now be given with respect to the case of using JPEG of the image processing CODEC for the compression section 2 and expansion section 3. The luminance signals Y and chrominance signals U, V to be inputted to the compression section 2 are formed into blocks each consisting of 8-signal horizontal×8-signal vertical for each signal type as shown in FIGS. 5A, 5B and 5C and are subjected to block-by-block compression processing at the compression section 2.

The compression section 2 is for generating encoded data of the predetermined-format luminance signal Y and chrominance signals U, V generated at the front-end section 1 and as previously described includes the frequency conversion section 2-1, quantization section 2-2 and encoding section 2-3. The frequency conversion section 2-1 effects discrete cosine transformation to convert the signals into spatial frequency components. The quantization section 2-2 then quantizes the spatial frequency components outputted from the frequency conversion section 2-1. The encoding section 2-3 then effects Huffman coding and run length coding of data obtained by effecting a zigzag scanning on the quantized spatial frequency components outputted from the quantization section 2-2.

The encoded data generated at the compression section 2 as the above are recorded in a memory or the like to be retained or are transmitted to a receiving side. The retained or transmitted, encoded data are then inputted into the expansion section 3.

The expansion section 3 is for processing the encoded data compressed at the compression section 2 so as to generate luminance signals Y and chrominance signals U, V in a predetermined format and as previously described includes the decoding section 3-1, inverse quantization section 3-2 and inverse frequency conversion section 3-3. The decoding section 3-1 effects a decoding by performing run length decoding and Huffman decoding. The inverse quantization section 3-2 then effects an inverse quantization for the spatial frequency components outputted from the decoding section 3-1. The inverse frequency conversion section 3-3 then generates luminance signals Y and chrominance signals U, V in a predetermined format by performing an inverse discrete cosine transformation of the inverse-quantized spatial frequency components outputted from the inverse quantization section 3-2. The predetermined-format luminance signal Y and chrominance signals U, V generated as the above are inputted into the back-end section 4.

The back-end section 4 is for processing the predetermined-format luminance signal Y and chrominance signals U, V that have been expanded at the expansion section 3 so as to generate image signals and as preciously described includes the inverse luminance/chrominance signal conversion section 4-1 and image signal generation section 4-2. The inverse luminance/chrominance signal conversion section 4-1 generates color signals R, G, B correspondingly to the processing at the pre-processing section 1-3 of the front-end section 1 from the predetermined-format luminance signal Y and chrominance signals U, V outputted from the expansion section 3. The image signal generation section 4-2 then generates image signals by performing a color-interpolating for effecting an interpolation for each color signal with respect to the predetermined color signals R, G, B outputted from the inverse luminance/chrominance signal conversion section 4-1. Thus generated image signals for example are reproduced as an image by an image reproducing apparatus or the like. The signal processing at the back-end section 4 will be described later in detail.

The operation of the preprocessing section 1-3 for generating the predetermined-format luminance signal Y and chrominance signals U, V in the present embodiment will now be described in detail.

In general, the equations for computing luminance signal Y and chrominance signals U, V from the color signals R, G, B are expressed as in [Formula 1].

Y=0.30R+0.59G+0.11B

U=0.70R−0.59G−0.11B

V=−0.30R−0.59G+0.89B [Formula 1]

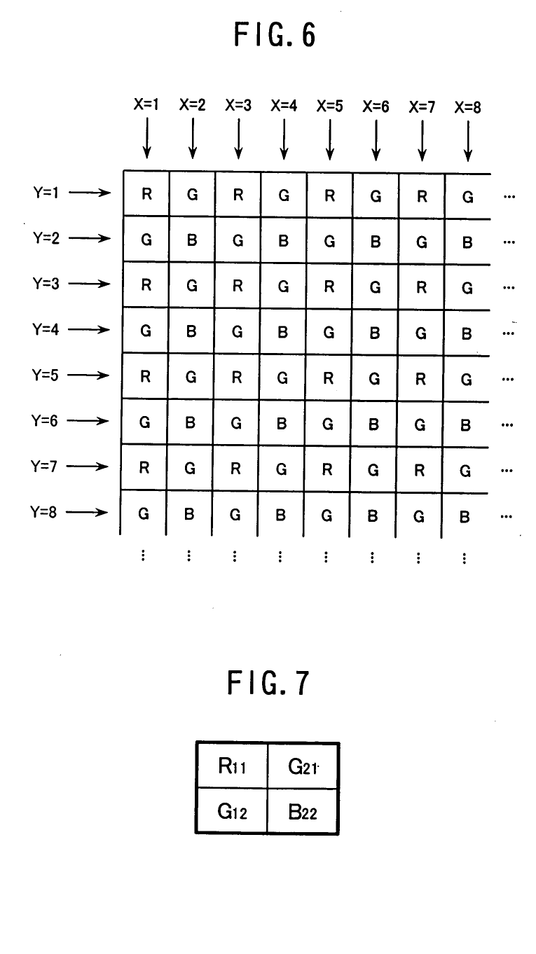

FIG. 6 typically represents a light-receiving surface of the solid-state imaging device 1-2. In the figure, R, G, B respectively indicate the pixels for receiving light transmitted through the color filter 1-1 consisting of the Bayer-arrayed primary-color filter. For ease of understanding in the following description, definitions are given as follows. Supposing in particular the coordinates of pixel R at the upper left corner in the figure as (1,1), the coordinates of pixel A at the location horizontally X and vertically Y from the pixel R is defined as (X,Y), and the output from pixel A is represented by A_{X Y}.

In the present invention, for all the color imaging signals outputted from the solid-state imaging device 1-2 having the color filter 1-1 constructed as the above, the luminance signal Y and chrominance signals U, V are generated based on the following principle and are outputted to the compression section 2. In particular, an observation is made with respect to one 2×2-array unit that contains pixels R₁₁, G₂₁, G₁₂, B₂₂ at the coordinates (1,1), (2,1), (1,2), (2,2) in FIG. 6. The pixels R₁₁, G₂₁, G₁₂, B₂₂ in the above described one unit consisting of 2×2 as shown in FIG. 7 are then used to compute luminance signals Y and chrominance signals U, V of the one unit based on the equations in [Formula 2].

Y1=0.30R₁₁+0.59G₂₁+0.11B₂₂

Y2=0.30R₁₁+0.59G₁₂+0.11B₂₂

U=0.70R₁₁−0.59G₁₂−0.11B₂₂

V=−0.30R₁₁−0.59G₂₁+0.89B₂₂ [Formula 2]

Subsequently, one 2×2-array unit containing the pixels at the coordinates (3,1), (4,1), (3,2), (4,2) adjacent in the X direction in FIG. 6 to the unit as indicated in FIG. 7 is observed to similarly compute the luminance signals Y and chrominance signals U, V of the adjacent unit.

In this manner, 2×2-array unit is translated horizontally (along X direction). When it has reached the right end in FIG. 6, one 2×2-array unit containing the pixels at the coordinates (1,3), (2,3), (1,4), (2,4) adjacent in the Y direction to the originating unit are observed and the luminance signals Y and chrominance signals U, V are similarly computed. As the above, the 2×2-array units in FIG. 6 are sequentially observed and luminance signals Y and chrominance signals U, V of each unit are computed so that the luminance signal Y and chrominance signals U, V in a predetermined format can be generated for all color imaging signals.

With the above technique, the luminance signal Y and chrominance signals U, V are generated at a ratio of Y:U:V=2:1:1 for the four pixel signals of one 2×2-array unit. Accordingly, the output data of the luminance signal and chrominance signals are generated of the same number as the total number of data of all color imaging signals inputted into the pre-processing section 1-3. In other words, the number of data becomes ⅓ as compared to the conventional case where luminance signal and chrominance signals are generated after effecting a color-interpolating of all color imaging signals.

By generating the luminance signal and chrominance signals with limiting the pixel arrangement of one unit to be observed to a narrow range such as 2×2 as described above, a correlation between the pixels within the unit can be achieved so as to minimize an error in the luminance signal Y and chrominance signals U, V. Accordingly, a degradation of image quality due to the smaller number of data to be compressed as compared to the conventionally used techniques can be controlled.

In the above description, the chrominance signal U is computed with using G₁₂ and chrominance signal V with using G₂₁ as indicated in [Formula 2] from one 2×2-pixel unit shown in FIG. 7. However, depending on image characteristics, it is also possible that chrominance signal U be computed with using G₂₁ and chrominance signal V with G₁₂ as indicated by the equations of [Formula 3].

Y1=0.30R₁₁+0.59G₂₁+0.11B₂₂

Y2=0.30R₁₁+0.59G₁₂+0.11B₂₂

U=0.70R₁₁−0.59G₂₁−0.11B₂₂

V=−0.30R₁₁−0.59G₁₂+0.89B₂₂ [Formula 3]

Further in [Formula 2] and [Formula 3], two luminance signals Y and one chrominance signal for each of U, V are computed from the pixels contained in one 2×2-array unit. It is however also possible that one luminance signal Y and one chrominance signal for each of U, V are computed with using an average of the two G signals for example as indicated by the equations of [Formula 4].

Y=0.30R₁₁+0.59(G₁₂+G₂₁)/2+0.11B₂₂

U=0.70R₁₁−0.59(G₁₂+G₂₁)/2−0.11B₂₂

V=−0.30R₁₁−0.59(G₁₂+G₂₁)/2+0.89B₂₂ [Formula 4]

With the generation technique of the luminance signal and chrominance signals according to [Formula 4] as the above, the luminance signal Y and chrominance signals U, V are provided at a ratio of Y:U:V=1:1:1. The number of data of the generated luminance signal Y and chrominance signals U, V thus becomes smaller as compared to the technique for computing two luminance signals Y and one chrominance signal for each of U, V according to [Formula 2] or [Formula 3]. It is thereby possible to further save power, since the amount of arithmetic operation at the front-end section 1 is reduced and the number of data to be processed at the compressing section 2 becomes smaller.

Further, in the above technique, 2×2-pixel array is used as one unit and the region of the unit is sequentially relocated so as to generate the luminance signal and chrominance signals based on the pixel signals of each unit. At that time in the described technique, the luminance signal and chrominance signals are generated with causing the sequential relocation so that the pixels of each relocated unit do not overlap those of another unit and at the same time that the units are adjoining each other. By contrast, it is also possible to relocate the 2×2-array unit so as to cause an overlap of pixels between each unit in sequentially computing the luminance signal Y and chrominance signals U, V for example such that, after computing the luminance signal Y and chrominance signals U, V from 2×2-array unit containing the pixels at the coordinates (1,1), (2,1), (1,2), (2,2) in FIG. 6, the luminance signal Y and chrominance signals U, V are computed from 2×2-array unit containing the pixels at the coordinates (2,2), (3,2), (2,3), (3,3) in FIG. 6.

Further, each unit has been shown as but not limited to one consisting of 2×2-pixel array, and a unit can also be formed by other arrangements of a plurality of pixels containing each color component.

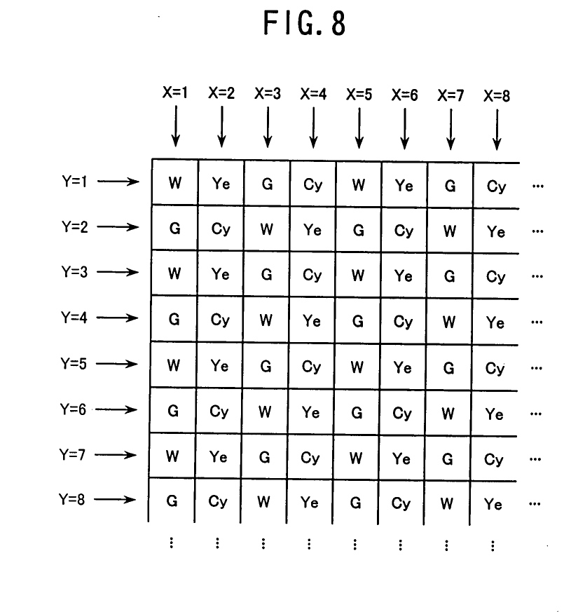

It should be noted that a complementary-color filter as shown in FIG. 4B may also be used instead of a primary-color filter as the color filter. In FIG. 8, definitions of the coordinates of pixels similar to those of the primary-color filter are given to the complementary-color filter. Here one unit is constituted by a plurality of pixels W, Ye, G, Cy containing each color component, and the predetermined-format luminance signal Y and chrominance signals U, V are computed with using such a unit.

According to the construction of the above described front-end section, the predetermined-format luminance signal Y and chrominance signals U, V are generated based on the color imaging signals obtained from the solid-state imaging device 1-2. The predetermined-format luminance signal Y and chrominance signals U, V are then subjected to the compression processing at the compression section 2. Accordingly, since a color-interpolating section for generating image signals based on color imaging signals obtained from the solid-state imaging device is not required, the number of data can be reduced and it is possible to achieve power saving in the process up to the compression of the color imaging signals obtained from the solid-state imaging device.

A detailed description will now be given with respect to the processing operation at the back-end section 4 for causing the processing corresponding to the described processing at the pre-processing section.

The back-end section 4 is for effecting the processing to generate image signals for the predetermined-format luminance signal Y and chrominance signals U, V expanded at the expansion section 3 and as previously described includes the inverse luminance/chrominance signal conversion section 4-1 and image signal generation section 4-2. The inverse luminance/chrominance signal conversion section 4-1 generates color signals R, G, B correspondingly to the processing at the pre-processing section 1-3 of the front-end section 1 from the predetermined-format luminance signal Y and chrominance signals U, V outputted from the expansion section 3.

The equations for computing color signals R, G, B from the luminance signal Y and chrominance signals U, V are generally an inverse operation of those in [Formula 1] and are expressed as in [Formula 5].

R=Y+U

G=Y−0.5U−0.19V

B=Y+V [Formula 5]

Accordingly, for example, the equations of the case for generating color signals R₁₁, G₁₂, G₂₁, B₂₂ from the luminance signals Y1, Y2 and chrominance signals U, V generated by the equations in [Formula 2] at the preprocessing section 1-3 are expressed as in [Formula 6]

R₁₁=Y1+U

G₁₂=Y2−0.5U−0.19V

G₂₁=Y1−0.5U−0.19V

B₂₂=Y2+V [Formula 6]

The color signals R, G, B in Bayer array outputted from the solid-state imaging device 1-2 of the front-end section 1 as shown in FIG. 6 can be generated by effecting the inverse operation processing shown in [Formula 6] at the inverse luminance/chrominance signal conversion section 4-1 with respect to all predetermined-format luminance signal Y and chrominance signals U, V outputted from the expansion section 3.

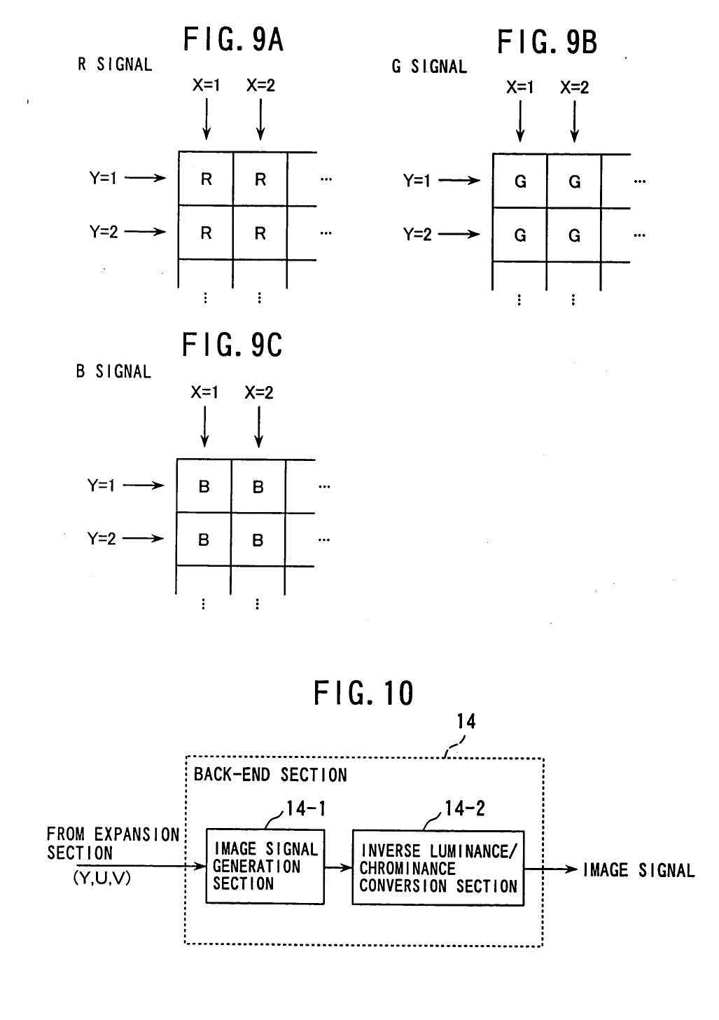

The image signal generation section 4-2 effects a color-interpolating as shown in FIGS. 9A, 9B and 9C for the color signals R, G, B arranged in the Bayer array shown in FIG. 6 outputted from the inverse luminance/chrominance signal conversion section 4-1 to generate image signals in RGB space which is a form of image signals. The image signals generated as the above may be reproduced as an image by an external equipment such as an image reproducing apparatus.

The above described back-end section 4 generates Bayer-array color signals R, G, B from the predetermined-format luminance signal Y and chrominance signals U, V at the inverse luminance/chrominance signal conversion section 4-1, and generates RGB-space image signals, a form of image signal, by the image signal generation section 4-2. By contrast, a back-end section 14 may also be constructed as shown in FIG. 10 with replacing the disposition of the inverse luminance/chrominance signal conversion section and that of the image signal generation section with each other.

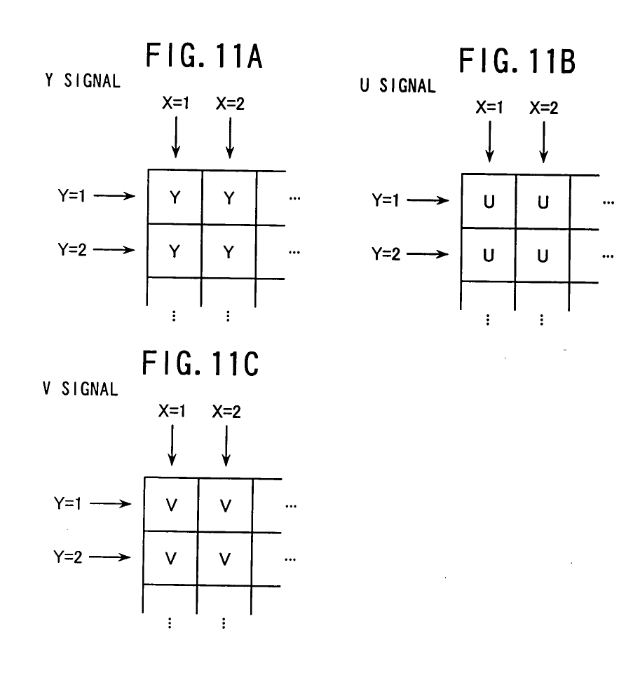

In thus constructed back-end section 14, an image signal generation section 14-1 effects a color-interpolating as shown in FIGS. 11A, 11B, 11C with respect to the predetermined-format luminance signal Y and chrominance signals U, V outputted from the expansion section 3 to generate image signals in YUV space.

An inverse luminance/chrominance signal conversion section 14-2 then effects an arithmetic processing shown in [Formula 5] based on the luminance signal Y and chrominance signals U, V on the same pixel with respect to the YUV space image signals outputted from the image signal generation section 14-1. The image signals in RGB space, a form of image signal shown in FIGS. 9A, 9B and 9C, are thereby generated. The image signals generated as the above may be reproduced as an image by an image reproducing apparatus or the like similarly to the image signals from the back-end section shown in FIG. 3.

It should be noted that, at the back-end section 14 of the construction shown in FIG. 10, a conversion is made from the image signals of YUV space shown in FIGS. 11A, 11B and 11C into the image signals of RGB space shown in FIGS. 9A, 9B and 9C. It is however also possible to treat the image signals of YUV space outputted from the image signal generation section 14-1 without change as the image signal for example to reproduce it as an image by an image reproducing apparatus or the like. In other words, the back-end section is only required to output image signals corresponding to an output format required by the external equipment in which the outputted image signal is used. Accordingly, the back-end section can also be called as a format conversion section.

As has been described by way of the above embodiment, since, according to the invention, the luminance signal and chrominance signals to be compressed are generated, without effecting a color-interpolating, from the color imaging signals obtained from a solid-state imaging device, a color-interpolating section is not required and the number of processing steps at the compression section can be reduced based on a reduction in the number of data so that an image compression apparatus and image processing system can be realized as capable both of saving power and of being reduced in size.

What is claimed is:

1. An image compression apparatus for compressing color imaging signals outputted from a solid-state imaging device having a color filter arranged in a Bayer array stuck on a light receiving surface thereof, said image compression apparatus comprising:
a pre-processing section for fetching signals from the color imaging signals outputted from said solid-state imaging device with treating the signals of 2×2 pixels corresponding to the Bayer array containing at least each color component signal as a unit, the pre-processing section for, with respect to each said unit, generating a luminance signal and one chrominance signal from R signal, one G signal and B signal and generating the luminance signal and the other chrominance signal from the R signal, the other G signal and the B signal of one unit; and
a compression section comprising: a frequency conversion section for computing spatial frequency components block by block of each signal component with respect to the luminance signals and two types of chrominance signals outputted from the pre-processing section; a quantization section for quantizing the spatial frequency components; and an encoding section for encoding the quantized spatial frequency components.

2. An image processing system comprising:
an image compression apparatus comprising: a pre-processing section for fetching signals from color imaging signals outputted from a solid-state imaging device having a color filter arranged in a Bayer array stuck on a light receiving surface thereof with treating the signals of 2×2 pixels corresponding to the Bayer array containing at least each color component signal as a unit, the pre-processing section for, with respect to each said unit, generating a luminance signal and one chrominance signal from R signal, one G signal and B signal and generating the luminance signal and the other chrominance signal from the R signal, the other G signal and the B signal of one unit; and a compression section comprising a frequency conversion section for computing spatial frequency components block by block of each signal component with respect to the luminance signals and two types of chrominance signals outputted from the pre-processing section, a quantization section for quantizing the spatial frequency components, and an encoding section for encoding the quantized spatial frequency components;
an expansion section comprising a decoding section for decoding spatial frequency components from the encoded data outputted from the image compression apparatus, an inverse quantization section for effecting an inverse quantization of the decoded spatial frequency components, and an inverse frequency conversion section for computing luminance signals and two types of chrominance signals block by block of each signal component based on the inverse-quantized spatial frequency components; and
a back-end section for generating image signals from the luminance signals and two types of chrominance signals outputted from the expansion section.

3. The image processing system according to claim 2, wherein said back-end section comprises a format conversion section for generating image signals in an outputting format required by an external equipment from the luminance signals and two types of chrominance signals outputted from said expansion section.

4. The image processing system according to claim 3, wherein said format conversion section comprises: an inverse luminance/chrominance signal conversion section for generating color signals from the luminance signals and two types of chrominance signals outputted from said expansion section; and an image signal generation section for color-interpolating the color signals generated from the inverse luminance/chrominance signal conversion section.

5. The image processing system according to claim 3, wherein said format conversion section comprises: an image signal generation section for color-interpolating the luminance signals and two types of chrominance signals outputted from said expansion section; and an inverse luminance/chrominance signal conversion section for generating color signals from the color-interpolated luminance signal and two types of chrominance signals.
